(19) United States
(12) Patent Application Publication
(10) Pub. No.: US 2025/0362014 A1
(43) Pub. Date: Nov. 27, 2025

(54) SYSTEMS AND METHODS FOR FLAMELESS COMBUSTION

(71) Applicant: Fives North American Combustion, Inc., Cleveland, OH (US)

(72) Inventors: Dennis E. Quinn, Hinckley, OH (US); Thomas F. Robertson, Medina, OH (US)

(21) Appl. No.: 18/829,847

(22) Filed: Sep. 10, 2024

Related U.S. Application Data
(60) Provisional application No. 63/651,643, filed on May 24, 2024.

(51) Int. Cl. F23C 6/04

(52) U.S. Cl. CPC F23C 6/047; F23C 2201/30; F23C 2700/04; F23C 2900/99001

(57) ABSTRACT

A method of providing flameless combustion includes forming a pre-heated reactant stream in a primary reaction zone by reacting a first stream of fuel and a first stream of undiluted oxidant and maintaining a combustible air/fuel ratio within flammability limits of the fuel. Forming a combustion stream by reacting a first stream of diluted oxidant, a second stream of fuel, and the pre-heated reactant stream in at least one secondary reaction zone downstream of the primary reaction zone. The combustion stream is maintained at a bulk combustion temperature below an auto-ignition temperature of the combustion stream. A composition of the combustion stream and the bulk combustion temperature are adjusted to maintain combustion marginally above a lower ignition limit boundary of the combustion stream. Upon the composition and the bulk combustion temperature reaching pre-determined flameless combustion conditions, the bulk combustion temperature is increased above an auto-ignition temperature of the combustion stream.

### CROSS REFERENCE TO RELATED APPLICATIONS

This application claims priority to U.S. Provisional Application No. 63/651,643 filed May 24, 2024, the entire contents of which are incorporated herein by reference.

### TECHNICAL FIELD

The present disclosure generally relates to systems and methods for heating a process chamber with a burner, and more specifically relates to flameless combustion.

### BACKGROUND

Flameless combustion has been proven to be highly effective in reducing nitrogen oxides (NOₓ) emissions and improving the temperature uniformity in a fuel/oxidant reaction process. These benefits provide significant value to many processes yielding flameless combustion as one of the preferred methods of combustion system design today. However, a significant challenge in implementing “flameless combustion” remains the requirement of high reaction temperature in order to maintain stable combustion.

### SUMMARY

An exemplary method of providing flameless combustion includes forming a reactant stream including a first stream of fuel and a first stream of undiluted oxidant in a primary reaction zone and maintaining a combustible air/fuel ratio in the primary reaction zone within flammability limits of the fuel. The method includes supplying an ignition source to the primary reaction zone to create a stable combustion reaction in the first reaction zone, wherein a thermal energy released from the stable combustion reaction heats up the reactant stream to form a pre-heated reactant stream. The method includes directing a first stream of diluted oxidant and a second stream of fuel to react with the pre-heated reactant stream to form a combustion stream in at least one secondary reaction zone downstream of the primary reaction zone. The method includes maintaining the combustion stream at a bulk combustion temperature below an auto-ignition temperature of the combustion stream and adjusting a composition of the combustion stream and the bulk combustion temperature to maintain combustion marginally above a lower ignition limit boundary of the combustion stream. Upon the composition and the bulk combustion temperature reaching pre-determined flameless combustion conditions, increasing the bulk combustion temperature of the combustion stream above an auto-ignition temperature of the combustion stream to achieve flameless combustion.

An exemplary apparatus configured for flameless combustion includes a combustion process zone including a primary reaction zone, at least one secondary reaction zone downstream of the primary reaction zone, and an ignition source configured to ignite combustion in the primary reaction zone. The apparatus includes a fuel supply system, an oxidant supply system, and a dilutant supply system coupled to and supply a fuel, an oxidant, and a dilutant to the combustion process zone. The apparatus also includes a control system including one or more memories including instructions and one or more processors configured to execute the instructions. The instructions when executed, cause the one or more processor to operate the fuel supply system, the oxidant supply system, and the dilutant supply system to execute a method of flameless combustion. The method includes forming a reactant stream including a first stream of fuel and a first stream of undiluted oxidant in a primary reaction zone. The method includes maintaining a combustible air/fuel ratio in the primary reaction zone within flammability limits of the fuel. The method includes supplying an ignition source to the primary reaction zone to create a stable combustion reaction in the first reaction zone, wherein a thermal energy released from the stable combustion reaction heats up the reactant stream to form a pre-heated reactant stream. The method includes directing a first stream of diluted oxidant and a second stream of fuel to react with the pre-heated reactant stream to form a combustion stream in at least one secondary reaction zone downstream of the primary reaction zone. The method includes maintaining the combustion stream at a bulk combustion temperature below an auto-ignition temperature of the combustion stream and adjusting a composition of the combustion stream and the bulk combustion temperature to maintain combustion marginally above a lower ignition limit boundary of the combustion stream. Upon the composition and the bulk combustion temperature reaching pre-determined flameless combustion conditions, increasing the bulk combustion temperature of the combustion stream above an auto-ignition temperature of the combustion stream to achieve flameless combustion.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1A shows an example conventional combustion method.

FIG. 1B shows an example combustion method according to the present disclosure.

FIG. 2 is a block diagram of an exemplary combustion system.

FIG. 3 is an illustration of a portion of an exemplary combustion system of FIG. 2.

FIG. 4 is another illustration of a portion of an exemplary combustion system of FIG. 2.

FIG. 5 is an exemplary method of providing flameless combustion using the combustion system of FIG. 2.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

Flameless combustion is a method of combusting a fuel (e.g., natural gas, hydrogen, coke oven gas, mixed gases and other hydrocarbon gaseous fuels or a combination thereof) and oxidant (e.g., oxygen or air) in an environment wherein the oxidant in the combustion zone is diluted to low concentrations, typically between 2% to 10% by volume (of the total volume of the combustion process zone) prior to combustion. At the low oxygen concentration, the combustion reaction only occurs at a minimum temperature above the auto-ignition temperature of the fuel and oxidant mixture (e.g., the temperature needs to be sufficiently high to initiate a reaction between the fuel and the oxidant). The common dilutant for oxygen may be reacted products of combustion and/or other non-combustion-reactive species, e.g., nitrogen, water, carbon dioxide, etc. The diluted oxidant and fuel are mixed and reacted in the high temperature (above auto-ignition) environment producing a flameless chemical reaction, normally not in the visible spectrum. In normal practice, the flameless combustion region is arrived at by running in a conventional firing mode (injecting, mixing and reacting fuel and oxidant without dilution) up to the fuel auto-ignition temperature. These conventional combustion/oxidation processes have a narrow operating range during startup and preheating steps, limited by normal fuel-air mixture combustion stability limits as a function of temperature. The conventional combustion/oxidation process requires heating above the auto-ignition temperature of the fuel to maintain a stable combustion. This results in high NOₓ emissions during the system heating up period.

The present disclosure is directed to systems and methods that overcome the high temperature requirement of current/conventional flameless combustion systems where the process needs to be heated above the auto-ignition temperature of the fuel to maintain stable combustion.

In particular, the systems and methods disclosed herein use a small part of the fuel (e.g., about 8%-12% by volume (of the total volume of the combustion process zone) mixed and reacted with a pure (undiluted) oxidant to create a “primary reaction zone” or “first reaction zone”. Since the oxidant is undiluted, the primary/first reaction zone is capable of achieving stable operation at a low or ambient temperature. In the primary/first reaction zone, an ignition source, e.g., a spark igniter, is sufficient to start and stabilize a flame reaction. The combustion in the primary/first reaction zone is not flameless but it releases thermal energy sufficient to increase the temperature of the reactants (e.g., the fuel and the oxidant).

The pre-heated reactants from the primary/first reaction zone are then further mixed and reacted in the next reaction zone, the at least one “secondary reaction zone” downstream of the primary/first reaction zone. A diluted oxidant stream, and optionally a second fuel stream, are introduced in the at least one secondary reaction zone. The amounts of pre-heated reactants, oxidant, fuel, dilutants, and the temperature (e.g., combustion temperature, flame temperature) are tuned/adjusted to produce a stable and sustainable combustion in the at least one secondary reaction zone. The temperature rise is a result of the combustion reaction of the mixture (e.g., the fuel and the undiluted and/or diluted oxidant). The volume ratios of the mixture are controlled/proportioned for stable combustion. The different reaction zones (e.g., the primary/first reaction zone and the at least one secondary reaction zone) are not necessarily separated from one another by structural means. The separation may be achieved fluid dynamically, to the extent that is possible given the high turbulence levels of each species (e.g., the fuel and the diluted/undiluted oxidant) are introduced into the combustion process zone.

In some embodiments, there may be more than one secondary reaction zones (e.g., the second, third, fourth, fifth reaction zones, etc.) to achieve the desired final combustion reaction of fuel and oxidant. The desired final combustion composition of the fuel and oxidant may vary depending on the types of combustion systems. In case of an industrial radiant tube combustion system, it is typically 10%-15% excess oxidant by volume (of the total volume of the combustion process zone). This “progressively” diluted combustion process results in stable combustion along the lower ignition limit boundary during the heating up operation as well as the prescribed final operating temperature for the heating process. The “10%-15% excess oxidant by volume” refers to the overall control volume, including all stages of the combustion process (e.g., at the end of the combustion process, the excess oxidant is 10%-15% by volume of the total volume of a combustion process zone). With more diluted stages (e.g., multiple secondary reaction zones) the amount of oxidant in each stage is adjusted/lowered to arrive at the overall level (e.g., 10%-15% excess oxidant by volume). More stages may allow more resolution at each stage which may imply more precise control of the combustion process (e.g., more precisely following a lower ignition boundary).

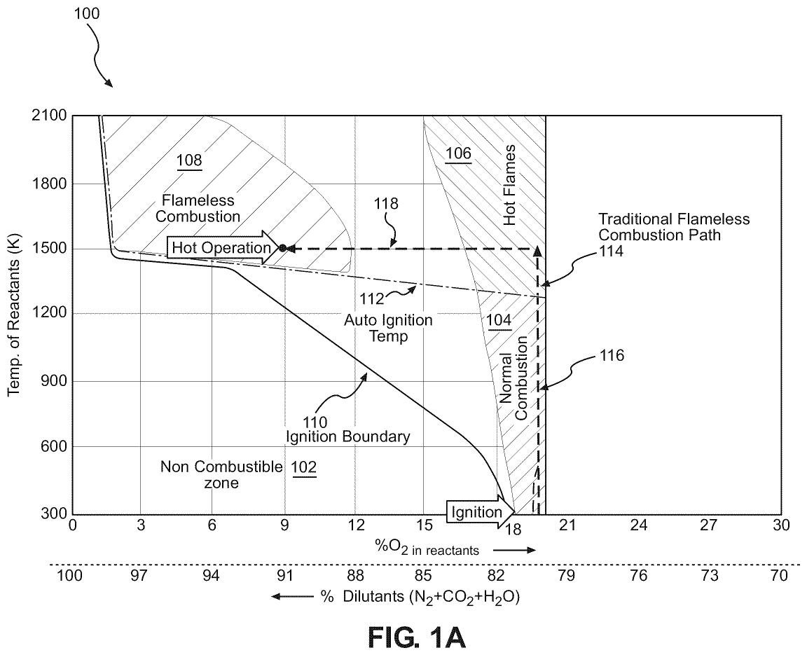

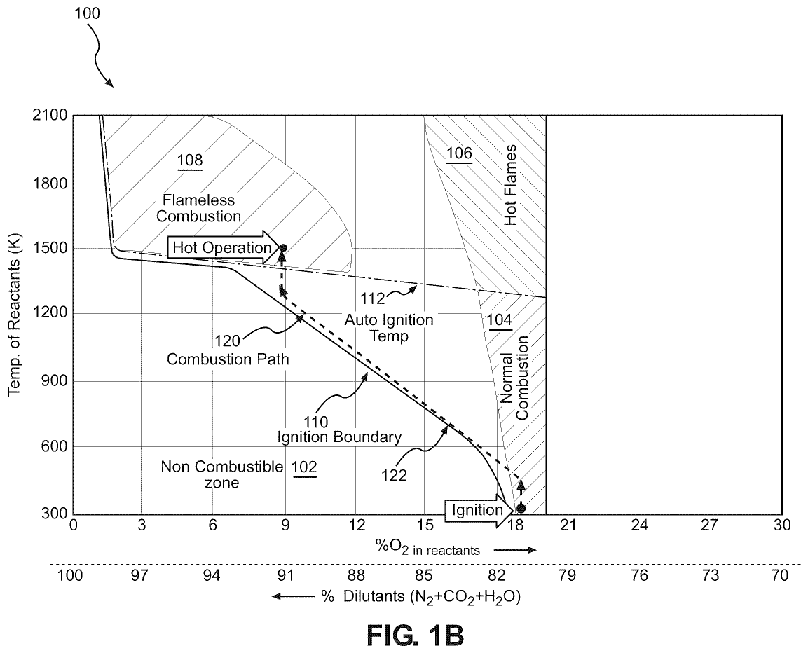

For comparison, an example conventional combustion method is shown in FIG. 1A, and an example combustion method according to the present disclosure is shown in FIG. 1B. In an exemplary combustion regimes diagram 100, depending on the amounts of oxygen (O₂) in the mixture and temperatures (Kelvin, K) of the mixtures, the combustion regimes include a non-combustible zone 102, a normal reaction zone 104, a hot flame zone 106, and a flameless reaction zone 108 divided by boundaries. These specifically include an ignition temperature boundary 110 and an auto-ignition temperature boundary 112.

A conventional combustion operation or path 114 typically follows two stages. During a first operating range 116, the reactants are reacted within the normal reaction zone 104 and heated up above the auto-ignition boundary or temperature 112 into the hot flame zone 106. During a second operating range 118, the oxidant is diluted to reach the flameless reaction zone 108 while the reactant temperature remains above the auto-ignition boundary or temperature 112. In the illustrated example, the % O₂ in the reactants is reduced from about 20% to about 9% by volume of the mixture during the second operating range 118. This binary operation results in high NOₓ production and the requirements of high temperature heating (e.g., at both above and below the auto-ignition boundary or temperature 112) may be problematic.

In contrast to the conventional combustion operation or path 114, the oxidant dilution is done in phases (e.g., in the at least one secondary reaction zones) in the present disclosure. The “phased introduction of dilution” is combined with the “phased energy release” allowing for stability to be maintained at all operation temperatures at the lowest temperatures and the lowest oxygen concentrations possible (e.g., along and just above the ignition boundary 110) thereby minimizing the NOₓ formation. As shown in FIG. 1B, a combustion operation or path 120 according to the present disclosure includes a phased dilution stage 122 along the ignition boundary 110. During the phased dilution stage 122, the temperature of the reactants is maintained significantly below the auto-ignition temperature 112 and the oxidant is diluted in phases. In the illustrated example, the combustion process is initiated within the normal reaction zone 104 at about 19% O₂ by volume (e.g., the primary/first reaction zone) and the oxidant is diluted through the at least one secondary reaction zone (e.g., the second, third, fourth, fifth reaction zones etc.) in the phased dilution stage 122. The combustion operation or path 120 is only above the auto-ignition temperature 112 when the % O₂ in reactants is within the flameless reaction zone 108. In the illustrated example, when the dilution reaches about 9% O₂ by volume, the reactant temperature is heated above the auto-ignition temperature 112 (e.g., heated by the thermal energy released from the stable combustion in the previous combustion stages). As such, the present disclosure overcomes the high heating temperature requirement and reduces the NOₓ production across the full operating range of the combustion system.

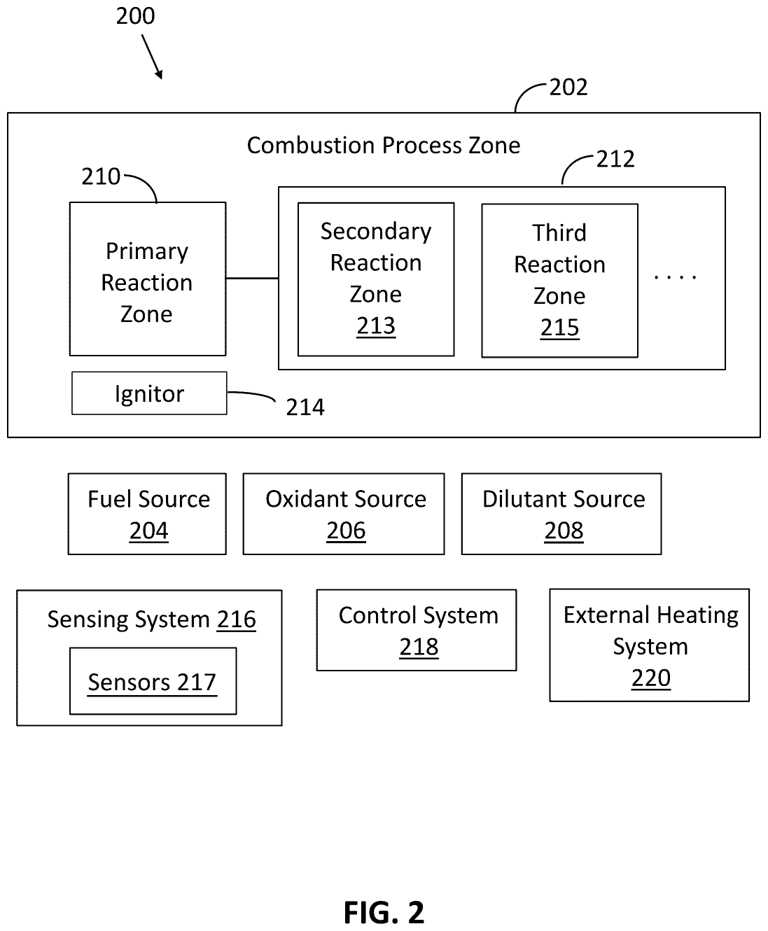

FIG. 2 shows a block diagram of an exemplary combustion system 200 for implementing the combustion operation or path 120. The combustion system 200 includes a combustion process zone 202 (e.g., the combustion process zone refers to a zone or space where combustion is initiated/sustained; the combustion process zone may include at least a portion of a burner and at least a portion of a combustion chamber) and a fuel source or supply system 204, an oxidant source or supply system 206, and a dilutant source or supply system 208 coupled to the combustion process zone 202. The fuel source 204 may include a supply of natural gas, hydrogen, coke oven gas, mixed gas or other gaseous hydrocarbon, or hydrocarbon derivative fuels, or a combination thereof. The oxidant source 206 may include a supply of air or oxygen. The dilutant source 208 may include a supply of the reactants of the fuel and the oxidant (e.g., recirculated reactants), a non-reactive gas (e.g., nitrogen, water, carbon dioxide, argon, etc.), or a combination thereof. Each of the fuel source or supply system 204, the oxidant source or supply system 206, and the dilutant source or supply system 208 may include any suitable systems and components, e.g., conduits, valves, pumps, sensors, etc., to supply controlled amounts of the fuel, oxidant, dilutant, and reactant to the combustion process zone 202 at controlled rates or flow speeds, such that the oxygen/fuel ratio can be controlled in the combustion process zone 202.

The combustion process zone 202 includes a primary or first reaction zone 210 and at least one secondary reaction zones 212 downstream of the primary or first reaction zone 210. The fuel source 204, the oxidant source 206, and the dilutant source 208 are in fluid communication with each section of the combustion process zone 202 (e.g., the primary or first reaction zone 210 and the at least one secondary/subsequent reaction zone 212).

The combustion system 200 includes an ignitor 214 (e.g., a spark igniter) to ignite combustion between the fuel and oxidant in the primary or first reaction zone 210.

In some embodiments, the combustion system 200 may include a sensing system 216 including one or more sensors 217, e.g., temperature sensors, gas sensors, flow sensors, etc., configured to monitor the temperature and/or concentration of the mixture in the combustion process zone 202 (e.g., the primary or first reaction zone 210 and the at least one secondary reaction zone 212).

In some embodiments, the combustion system 200 may include an external heating system 220 configured to supply an external heat/thermal energy to the combustion process zone 202 and/or any subsystems of the combustion system 200, such as the dilutant source 208. The external heating system 220 may offer additional temperature control of the combustion process zone 202. For example, the external heating system 220 may allow options for intermediate preheating of each zone (e.g., the primary and/or secondary reaction zones), in addition to the heat/thermal generated from the previous combustion stages. The external heating system 220 may include a co-firing and/or a burner of alternative fuels or electricity, etc.

The combustion system 200 may include a control system or controller 218 communicatively and operatively coupled to components and systems within the combustion system 200 to control operation of the combustion system 200. The control system or controller 218 is configured to operate and coordinate the operation of the combustion system 200. The control system or controller 218 may be a computer or may include any suitable processer(s), microprocessor(s), transceiver(s), memory (e.g., transitory or non-transitory memory), a timer, analog-to-digital convertor(s) (ADC), programmable logic controller(s) (PLC), human machine interface(s) (HMI), etc. to enable its functions. The control system or controller 218 may include any suitable user interface and/or display to allow output of the test results and allow a user to program or control the operation of the combustion system 200. The control system or controller 218 may perform combustion operation following pre-programmed procedures and/or may perform dynamic analyses to dynamically control/update the combustion operation in-situ.

The combustion system 200 may be any combustion system, e.g., a radiant tube, an industrial heating furnace, a gas turbine, a gas burner, etc.

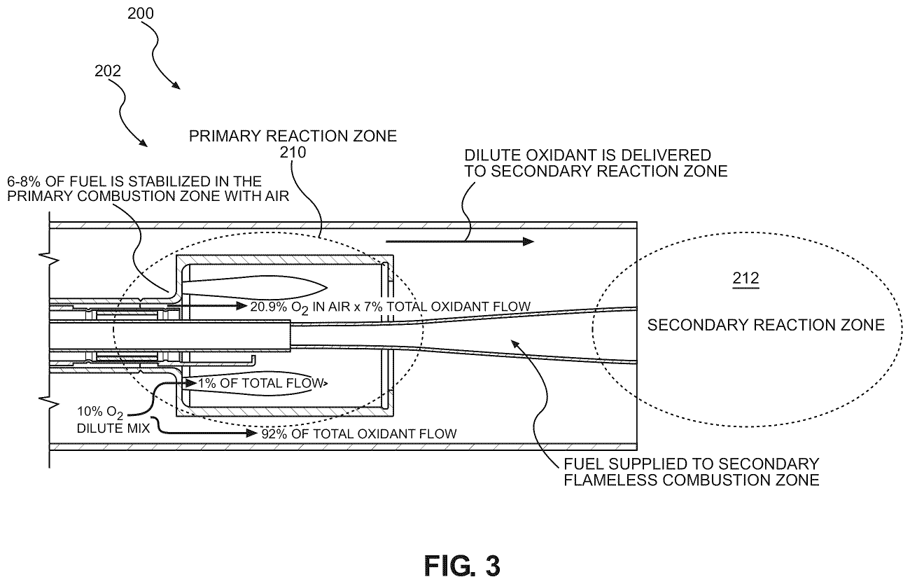

FIG. 3 is an illustration of a portion of an exemplary combustion system of FIG. 2 (e.g., the combustion system 200). In the illustrated example, about 6%-about 8% by volume of fuel is stabilized in the combustion process zone 202 (e.g., the combustion process zone refers to a zone or space where combustion is initiated/sustained; the combustion process zone may include at least a portion of a burner and at least a portion of a combustion chamber) with air. The fuel of about about 6%-about 8% by volume react with undiluted oxidant of about 7% by volume in the primary reaction zone 210. In the illustrated example, air is used as the oxidant; therefore, the amount of oxygen (O₂) introduced into the primary reaction zone 210 is 20.9% O₂×7% by volume of total oxidant flow. The pre-heated reactant stream flows from the primary reaction zone 210 into the secondary reaction zone 212. In the illustrated example, a first stream of diluted oxidant including 10% O₂×92% by volume of total oxidant flow, a second stream of fuel, and the pre-heated reactant stream react to form a combustion stream in the at least one secondary reaction zone 212 downstream of the primary reaction zone 210. The amount of O₂ in the first stream of diluted oxidant is about 1% by volume of the total oxidant flow.

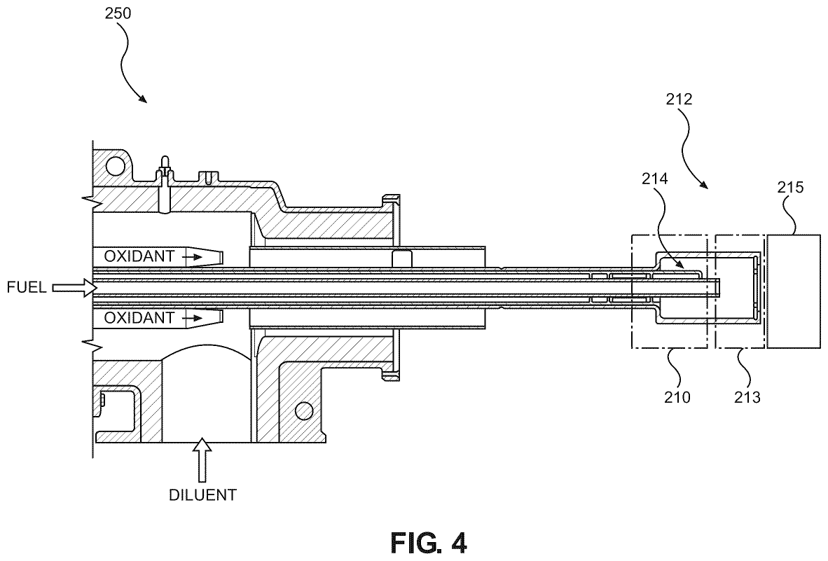

FIG. 4 is an illustration of a portion an exemplary a three-stage combustion system 250 expanding upon the example shown in FIG. 3. The fuel, the oxidant, and the diluent are supplied in the three-stage combustion system 250 as shown in FIG. 4 (on the left side). The at least one secondary reaction zone 212 includes a second reaction zone 213 downstream of the primary reaction zone 210 and a third reaction zone 215 downstream of the second reaction zone 213.

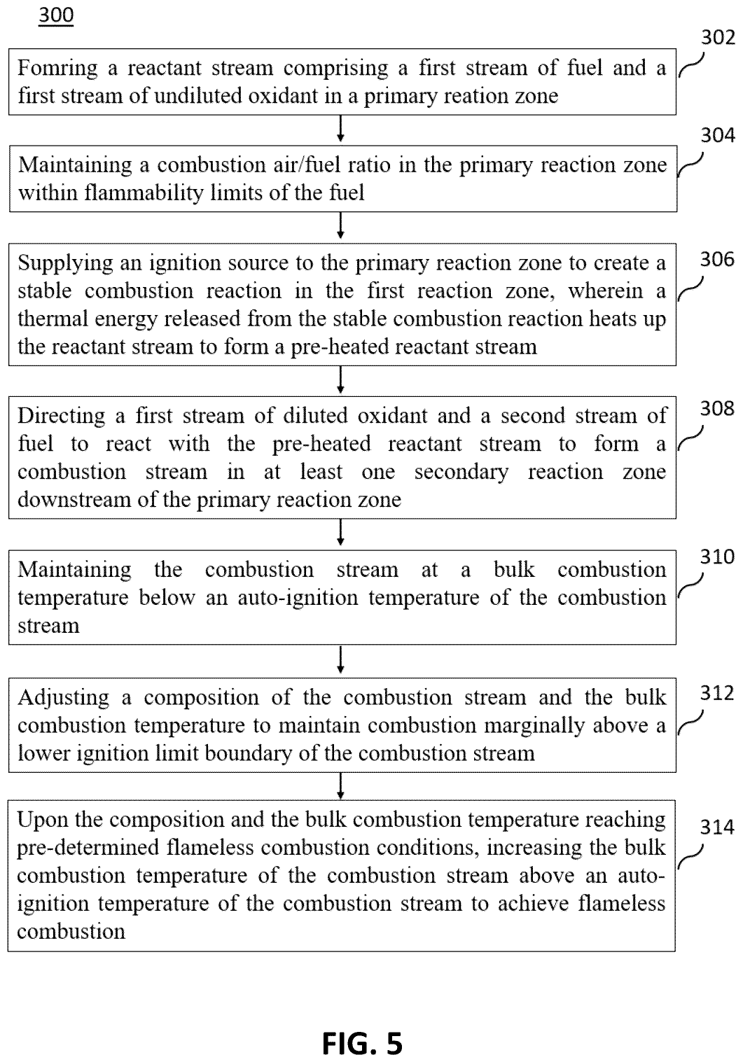

FIG. 5 shows an exemplary method 300 of operating the combustion system 200. The method 300 maybe a computer-implemented method. In particular, the method 300 includes one or more instructions, and the combustion system 200 includes the control system 218 that includes one or more memories storing the one or more instructions and one or more processors configured to execute the one or more instructions when executed.

The method 300 includes forming a reactant stream comprising a first stream of fuel and a first stream of undiluted oxidant (e.g., air) in a primary reaction zone 210 of the combustion system 200 (step 302) and maintaining a combustible air/fuel ratio in the primary reaction zone within flammability limits of the fuel (step 304). Step 302 may include forming the reactant stream such that an amount of the oxidant (e.g., air) is about 6% to about 12% by volume (of the combustion process zone 202). The control system 218 is communicatively and operatively coupled to the fuel source 204 and the oxidant source 206 and configured to control the flow rate and/or amount of each flow to achieve desired amounts of oxidant (e.g., air) and fuel in the reactant stream. For example, the flow rates and/or amounts of the fuel and oxidant are controlled such that the combustible air/fuel ratio is within the limits of the normal reaction zone 104 (in FIG. 1B).

The method 300 includes supplying an ignition source to the primary reaction zone 210 to create a stable combustion reaction in the first reaction zone 210 (step 306) wherein a thermal energy released from the stable combustion reaction heats up the reactant stream to form a pre-heated reactant stream. The control system 218 is communicatively and operatively coupled to the ignitor 214 to ignite the reactant stream. The control system 218 may be further configured to adjust the flow rate and/or amount of each of the fuel flow and the oxidant flow as to adjust/control the pre-heating temperature of the pre-heated reactant stream at a desired value or range. The desired pre-heating temperature may be determined based on the combustion regimes diagram 100 of the specific fuel or combustion system. The pre-heating temperature is sufficiently high above the ignition boundary (e.g., in the normal combustion range 104 in FIG. 1B) for the respective fuel to oxidant ratio to initiate stable combustion. The pre-heating temperature maybe above the ignition temperature 110 (in FIG. 1B) and below the auto-ignition temperature 112 (in FIG. 1B) for the respective fuel to oxidant ratio. The pre-heating temperature may be about 0.1% to about 100%, about 0.1% to about 80%, about 0.1% to about 50%, about 0.1% to about 30%, or about 0.1% to about 10% above the ignition temperature for the respective fuel to oxidant ratio.

The method 300 includes directing a first stream of diluted oxidant and a second stream of fuel to react with the pre-heated reactant stream to form a combustion stream in at least one secondary reaction zone 212 downstream of the primary reaction zone 210 (step 308) and maintaining the combustion stream at a bulk combustion temperature below an auto-ignition temperature of the combustion stream (step 310). Herein the “bulk combustion temperature” refers to the overall or average temperature of the mixture in the combustion process zone 202.

The control system 218 is operatively and communicatively coupled to the fuel source 204 and the dilutant source 208 and configured to control the flow rate and/or amount of each flow to achieve and desired amounts of oxidant and fuel in the combustion stream. The fuel may be introduced into the at least one secondary reaction zone 212 via the fuel in the pre-heated reactant stream and/or via a fuel stream separate from that supplied to the primary/first reaction zone 210. The control system 218 may be configured to direct a second stream of fuel into the at least one secondary reaction zone 212.

The method 300 includes adjusting a composition of the combustion stream and the bulk combustion temperature to maintain combustion marginally above (e.g., about 50 degree Celsius, ° C., to about 100° C. above) and along a lower ignition limit boundary of the combustion stream (step 312) and below or substantially below the auto-ignition temperature 112 (in FIG. 1B). Step 312 may include adjusting the flow rate and/or amount of each of the fuel flow, the oxidant flow, the dilutant flow as to achieve and maintain the bulk combustion temperature at a desired value or range. The desired bulk combustion temperature may be determined based on the combustion regime diagrams 100 of the specific fuel and/or the combustion system. Step 312 may include maintaining the bulk combustion temperature above the ignition boundary for the respective fuel to oxidant ratio to maintain stable combustion. Specifically, the bulk combustion temperature is above the ignition temperature and below the auto-ignition temperature for the respective fuel to oxidant ratio. The bulk combustion temperature may be in a range of about 600 K to about 1500 K for the fuel:oxidant ratio of about 1:8 to about 1:12 for air as the oxidant. The bulk combustion temperature may be about 0.1% to about 100%, about 0.1% to about 80%, about 0.1% to about 50%, about 0.1% to about 30%, about 0.1% to about 10%, about 0.1 to about 5%, or about 0.1 to about 3% above the ignition temperature for the respective fuel to oxidant ratio.

The method 300 includes upon the composition and the bulk combustion temperature reaching pre-determined flameless combustion conditions, increasing the bulk combustion temperature of the combustion stream above an auto-ignition temperature 112 (in FIG. 1B) of the combustion stream to achieve flameless combustion (step 314). The pre-determined flameless combustion conditions (e.g., temperature and composition of the combustion stream) may be determined based on the combustion regimes diagram 100 of the specific fuel and/or the specific combustion system. The pre-determined flameless combustion conditions may be that the oxidant (e.g., air) in an amount of about 6% to about 12% by volume at a temperature range of about 1500 K to about 1800 K.

The method 300 may optionally include monitoring a composition and/or a temperature of the mixture in the primary/first reaction zone 210 and the at least one secondary reaction zone 212. The control system 218 is communicatively coupled to the sensing system 216 to monitor the composition and/or the temperature of the mixtures in the primary/first reaction zone 210 and the at least one secondary reaction zone 212.

The method 300 may include forming the reactant stream such that an amount of the oxidant (e.g., air) is about 6% to about 18% of the reactant stream by volume. The method of 300 may include forming the reactant stream such that an amount of the fuel is about 8% to about 80% of the reactant stream by volume. The method of 300 may include adjusting the composition of the combustion stream such that a fuel:oxidant ratio of the combustion stream is in a range of about 1:8 to about 1:12. The method 300 may include adjusting the bulk combustion temperature in a range of about 600 K to about 1500 K or about 600 K to about 1200 K. The method 300 may include mixing a second stream of undiluted oxidant (e.g., air) and a stream of dilutant to form the first stream of diluted oxidant. The method 300 may include heating the stream of dilutant during or prior to mixing with the second stream of undiluted oxidant. The method of 300 may include directing at least a portion of the pre-heated reactant to form the stream of dilutant. In some embodiments, the second stream of fuel may be a separate stream from the first stream of fuel. In some embodiment, the second stream of fuel is from or including the fuel from the first stream of fuel. The method 300 may include supplying an external heating source to the primary reaction zone and/or the at least one secondary reaction zone to adjust the bulk combustion temperature.

As used herein, the term “%”, unless otherwise specified, refers to % by volume of the total volume of the combustion process zone 202.

As used herein, the term “oxidant”, unless otherwise specified, refers to air (e.g., 79% nitrogen and 21% oxygen).

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

In one aspect, a method may include an operation, an instruction, and/or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

The functions, acts or tasks illustrated in the Figures or described may be executed in a digital and/or analog domain and in response to one or more sets of logic or instructions stored in or on non-transitory computer readable medium or media or memory. The functions, acts or tasks are independent of the particular type of instructions set, storage media, processor or processing strategy and may be performed by software, hardware, integrated circuits, firmware, microcode and the like, operating alone or in combination. The memory may comprise a single device or multiple devices that may be disposed on one or more dedicated memory devices or disposed on a processor or other similar device. When functions, steps, etc. are said to be “responsive to” or occur “in response to” another function or step, etc., the functions or steps necessarily occur as a result of another function or step, etc. It is not sufficient that a function or act merely follow or occur subsequent to another. The term “substantially” or “about” encompasses a range that is largely (anywhere a range within or a discrete number within a range of ninety-five percent and one-hundred and five percent), but not necessarily wholly, that which is specified. It encompasses all but an insignificant amount.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112(f) unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A method of providing flameless combustion, comprising:
forming a reactant stream comprising a first stream of fuel and a first stream of undiluted oxidant in a primary reaction zone;
maintaining a combustible air/fuel ratio in the primary reaction zone within flammability limits of the fuel;
supplying an ignition source to the primary reaction zone to create a stable combustion reaction in the first reaction zone, wherein a thermal energy released from the stable combustion reaction heats up the reactant stream to form a pre-heated reactant stream;
directing a first stream of diluted oxidant and a second stream of fuel to react with the pre-heated reactant stream to form a combustion stream in at least one secondary reaction zone downstream of the primary reaction zone;
maintaining the combustion stream at a bulk combustion temperature below an auto-ignition temperature of the combustion stream;
adjusting a composition of the combustion stream and the bulk combustion temperature to maintain combustion marginally above a lower ignition limit boundary of the combustion stream; and
upon the composition and the bulk combustion temperature reaching pre-determined flameless combustion conditions, increasing the bulk combustion temperature of the combustion stream above an auto-ignition temperature of the combustion stream to achieve flameless combustion.

2. The method of claim 1, further comprising forming the reactant stream such that an amount of the oxidant is about 6% to about 18% of the reactant stream by volume.

3. The method of claim 1, further comprising forming the reactant stream such that an amount of the fuel is about 8% to about 80% of the reactant stream by volume.

4. The method of claim 1, further comprising adjusting the composition of the combustion stream such that a fuel:oxidant ratio of the combustion stream is in a range of about 1:8 to about 1:12.

5. The method of claim 1, further comprising adjusting the bulk combustion temperature in a range of about 600 K to about 1500 K or about 600 K to about 1200 K.

6. The method of claim 1, further comprising mixing a second stream of undiluted oxidant and a stream of dilutant to form the first stream of diluted oxidant.

7. The method of claim 6, further comprising heating the stream of dilutant during or prior to mixing with the second stream of undiluted oxidant.

8. The method of claim 6, further comprising directing at least a portion of the pre-heated reactant to form the stream of dilutant.

9. The method of claim 1, wherein the second stream of fuel comprises at least a portion of the fuel from the first stream of fuel.

10. The method of claim 1, further comprising supplying an external heating source to the primary reaction zone and/or the at least one secondary reaction zone to adjust the bulk combustion temperature.

11. The method of claim 1, wherein the oxidant is air.

12. The method of claim 1, wherein the at least one secondary reaction zone comprises two or more secondary reaction zones.

13. An apparatus configured for flameless combustion, comprising:
a combustion process zone, comprising:
a primary reaction zone;
at least one secondary reaction zone downstream of the primary reaction zone;
an ignition source configured to ignite combustion in the primary reaction zone;
a fuel supply system, an oxidant supply system, and a dilutant supply system coupled to and supply a fuel, an oxidant, and a dilutant to the combustion process zone; and
a control system, comprising:
one or more memories comprising instructions; and
one or more processors configured to execute the instructions, which, when executed, cause the one or more processor to operate the fuel supply system, the oxidant supply system, and the dilutant supply system to execute a method of flameless combustion, the method comprising:
forming a reactant stream comprising a first stream of fuel and a first stream of undiluted oxidant in a primary reaction zone;
maintaining a combustible air/fuel ratio in the primary reaction zone within flammability limits of the fuel;
supplying an ignition source to the primary reaction zone to create a stable combustion reaction in the first reaction zone, wherein a thermal energy released from the stable combustion reaction heats up the reactant stream to form a pre-heated reactant stream;
directing a first stream of diluted oxidant and a second stream of fuel to react with the pre-heated reactant stream to form a combustion stream in at least one secondary reaction zone downstream of the primary reaction zone;
maintaining the combustion stream at a bulk combustion temperature below an auto-ignition temperature of the combustion stream;
adjusting a composition of the combustion stream and the bulk combustion temperature to maintain combustion marginally above a lower ignition limit boundary of the combustion stream; and
upon the composition and the bulk combustion temperature reaching pre-determined flameless combustion conditions, increasing the bulk combustion temperature of the combustion stream above an auto-ignition temperature of the combustion stream to achieve flameless combustion.

14. The apparatus of claim 13, wherein the method further comprises forming the reactant stream such that an amount of the oxidant is about 6% to about 18% of the reactant stream by volume.

15. The apparatus of claim 13, wherein the method further comprises forming the reactant stream such that an amount of the fuel is about 8% to about 80% of the reactant stream by volume.

16. The apparatus of claim 13, wherein the method further comprises adjusting the composition of the combustion stream such that a fuel:oxidant ratio of the combustion stream is in a range of about 1:8 to about 1:12.

17. The apparatus of claim 13, wherein the method further comprises adjusting the bulk combustion temperature in a range of about 600 K to about 1500 K or about 600 K to about 1200 K.

18. The apparatus of claim 13, wherein the method further comprises mixing a second stream of undiluted oxidant and a stream of dilutant to form the first stream of diluted oxidant.

19. The apparatus of claim 18, wherein the method further comprises heating the stream of dilutant during or prior to mixing with the second stream of undiluted oxidant.

20. The apparatus of claim 18, wherein the method further comprises directing at least a portion of the pre-heated reactant to form the stream of dilutant.

21. The apparatus of claim 13, wherein the second stream of fuel comprises at least a portion of the fuel from the first stream of fuel.

22. The apparatus of claim 13, further comprising an external heating system, and the method further comprises supplying an external heating source generated by the external heating system to the primary reaction zone and/or the at least one secondary reaction zone to adjust the bulk combustion temperature.

23. The apparatus of claim 13, wherein the oxidant is air.

24. The apparatus of claim 13, wherein the at least one secondary reaction zone comprises two or more secondary reaction zones.
